(19) United States
(12) Patent Application Publication
(10) Pub. No.: US 2010/0321243 A1
(43) Pub. Date: Dec. 23, 2010

(54) BACKGROUND POSITION FIX PRIOR TO REQUEST

(75) Inventor: Mayur N. Shah, West Orange, NJ (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/487,320

(22) Filed: Jun. 18, 2009

(51) Int. Cl. G01S 3/02

(52) U.S. Cl. 342/451; 342/450

(57) ABSTRACT

A mobile station determines a usage pattern based on information stored from previous position fixes. The usage pattern is used to predict a time for a next position fix request. The mobile station performs a position fix in the background prior to the predicted time for the next position fix request. The background position fix provides the precise location and time of the mobile station to place the mobile station in a “hot” state. The prediction of the time for the next position fix request may be affected by the remaining battery power and/or the last known location of the mobile station. Additionally, the difference between the predicted time and the actual time of the next position fix request may be used to adjust subsequent predictions of the time for the next position fix request.

### BACKGROUND

A common means by which to locate a device is to determine the amount of time required for signals transmitted from multiple sources at known locations to reach a receiver within the device to be located. One system that provides signals from a plurality of transmitters of known location is a satellite positioning system (SPS), such as the well-known Global Positioning Satellite (GPS) system, which employs a number of satellites that are in orbit around the Earth. A receiver receives the signals from the satellites and processes those signals to derive precise navigation information including 3-dimensional position, velocity and time of day. Position measurements using SPS are based on measurements of propagation delay times of SPS signals broadcast from the orbiting satellites to the SPS receiver. Once the receiver has measured the signal propagation delays for each satellite, the range to each satellite can be determined and the location of the receiver can be determined using the measured ranges and the known locations of the satellites.

The location of the satellites within the SPS system can be identified by a number of different pieces of information. For example, the almanac and ephemeris provide information regarding the location of all of the satellites in the “constellation”, where the ephemeris information is more accurate than the almanac information. Both the almanac and the ephemeris information is valid for a limited amount of time, e.g., the almanac is accurate for approximately one week and the ephemeris is accurate for approximately 4 hours.

When an SPS receiver has already acquired the satellite signals and has determined a fix of the position of the SPS receiver, the subsequent determination of position is fast. However, when the SPS receiver is powered on, or brought out of a sleep mode, a first position fix must be performed. The Time to First Fix (TTFF) is the time it takes to perform this first position fix. Several factors affect the TTFF including whether the SPS receiver has valid almanac and ephemeris data, the length of time from the last position fix and whether there is a significant change in the location of the SPS receiver since the last position fix. For example, in a “cold start” mode, where the SPS receiver does not know the current time, position, or has inaccurate ephemeris, but with strong satellite signals, the TTFF may be 40-45 seconds, whereas in a “hot start” mode, where the SPS receiver has recently established a position fix and has current ephemeris data, the TTFF may 1-2 seconds.

### SUMMARY

A mobile station performs a position fix in the background prior to an actual position fix request by predicting the time of the next position fix request based on prior usage. The mobile station stores usage information from previous position fix requests and determines a usage pattern based on the stored usage information. The usage pattern is used to predict a time for a next position fix request. The mobile station can then perform a position fix in the background prior to the predicted time for the next position fix request. The remaining battery power and/or the last known location of the mobile station may influence the prediction of the time for the next position fix request. Additionally, the difference between the predicted time and the actual time of the next position fix request may be used to adjust subsequent predictions of the time for the next position fix request.

### BRIEF DESCRIPTION OF THE DRAWINGS

FIG. 1 illustrates a mobile station that receives signals from SPS satellites, cellular towers, or wireless internet and is capable of performing a background position fix.

FIG. 2 is an illustrative block diagram of the mobile station capable of determining a background position fix before the next request for a position fix is made, e.g., at power-up.

FIG. 3 is a flow chart illustrating a method of performing a background position fix with a mobile station before the next request of a position fix is made.

FIG. 4 is a table illustrating a usage pattern in the form of a likelihood function for a single day.

FIG. 5 is a flow chart illustrating the use of a threshold value in the prediction of the time for the next position fix request.

FIG. 6 is a flow chart illustrating a method of improving future predictions of the time for a next position fix request based on the difference between a predicted time and the actual time for the next position fix request.

### DETAILED DESCRIPTION

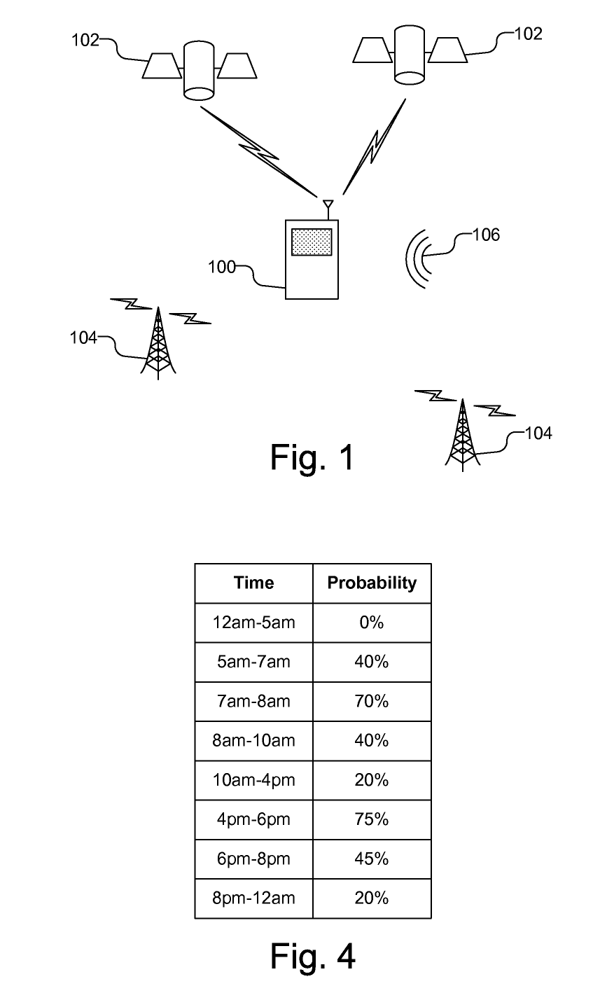

FIG. 1 illustrates a mobile station 100 that is capable of performing a background position fix as described below. The mobile station 100 may receive and process positioning signals received from, e.g., satellites 102 to perform a position fix.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The mobile station 100, however, is not limited to use with an SPS, but position determination techniques described herein may be implemented in conjunction with various wireless communication networks, including cellular towers 104 and from wireless communication access points 106, such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN. The techniques may also be implemented in conjunction with any systems involving femtocells.

As used herein, a mobile station refers to a device that is capable of determining position location and may be, e.g., a dedicated SPS receiver, including a handheld or vehicular mounted system, or cellular or other wireless communication device, personal communication system (PCS) device, personal navigation device, Personal Information Manager (PIM), Personal Digital Assistant (PDA), laptop or other suitable mobile device which is capable of receiving wireless signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

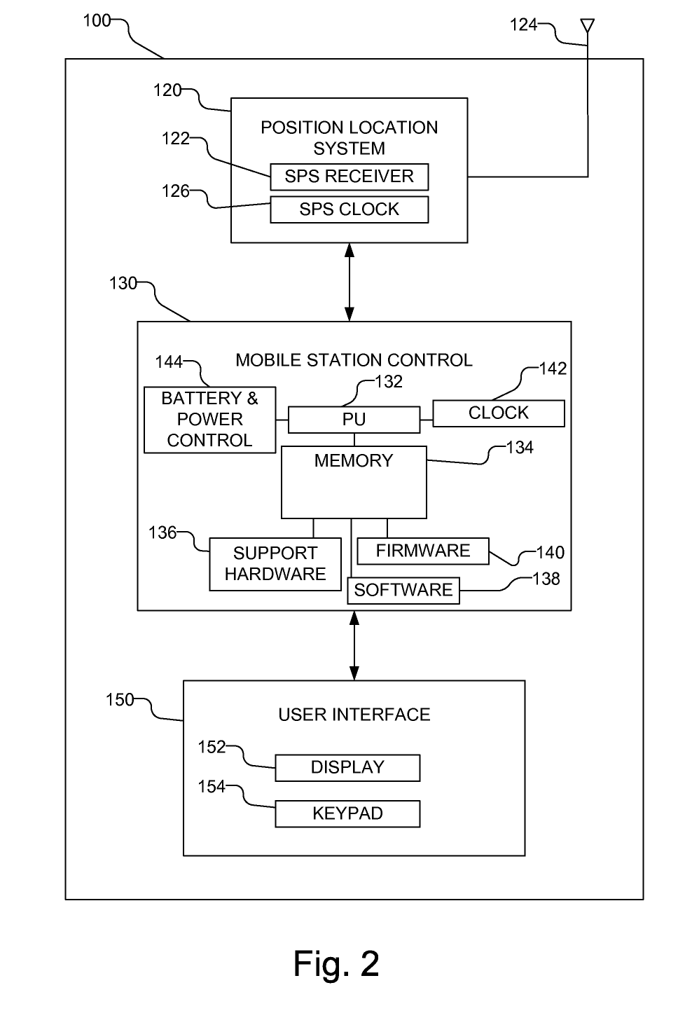

FIG. 2 is an illustrative block diagram of the mobile station 100 capable of determining a background position fix before a request for a position fix is made. The request for a position fix may be made, e.g., by powering-up or waking the mobile station 100 from a sleep mode. Mobile station 100 includes a position location system 120, such as a system including an SPS receiver 122 that receives signals from SPS satellites 102 (FIG. 1) via an antenna 124 and an SPS clock 126. As discussed, the position location system 120 need not be limited to an SPS, but may use signals obtained from terrestrial sources, such as cellular towers 104 or from wireless communication access points 106. In such embodiments, the position location system 120 may be, e.g., a cellular modem or a wireless network receiver/transmitter that is capable of receiving communications from a cellular tower or from a wireless access point, respectively.

The position location system 120 can be coupled to and can communicate with a mobile station control 130, e.g., the mobile station control 130 accepts data and controls the position location system 120. The mobile station control 130 can include a processing unit 132 and associated memory 134 (e.g., coupled to processing unit 132), support hardware 136, software 138, and firmware 140. Additionally, the mobile station control 130 may include a clock 142 as well as a battery and power control unit 144. In some embodiments, the clock 142 also serves as the SPS clock 126. The battery and power control unit 144 is in communication with the processing unit 132 and is adapted to provide data on the current battery power to the processing unit 132. It will be understood as used herein that the processing unit 132 can, but need not necessarily include, one or more microprocessors, embedded processors, controllers, application specific integrated circuits (ASICs), digital signal processors (DSPs), and the like. The term processing unit is intended to describe the functions implemented by the system rather than specific hardware. Moreover, as used herein the term “memory” refers to any type of computer storage medium, including long term, short term, or other storage associated with the mobile station, and is not to be limited to any particular type of memory or number of memories, or type of media upon which memory is stored.

The mobile station 100 also includes a user interface 150 that is in communication with the mobile station control 130, e.g., the mobile station control 130 accepts data and controls the user interface 150. The user interface 150 includes a display 152 that displays position information as well as control menus and a keypad 154 or other input device through which the user can input information into the mobile station 100. In one embodiment, the keypad 154 may be integrated into the display 152, such as a touch screen display. The user interface 150 may also include, e.g., a microphone and speaker, e.g., when the mobile station 100 is a cellular telephone.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 134 and executed by the processor 132. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

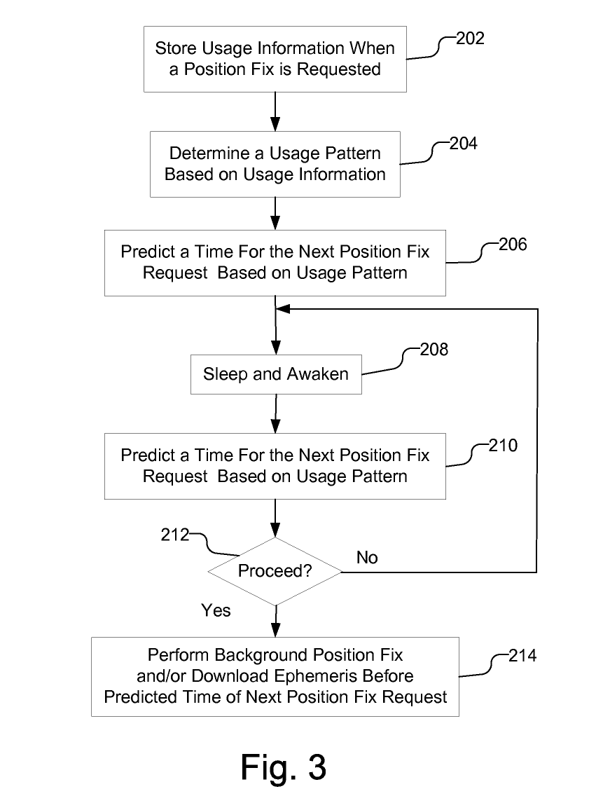

FIG. 3 is a flow chart showing a method of performing a background position fix with a mobile station before a request for the next position fix is made. As illustrated in FIG. 3, the mobile station stores usage information, e.g., in memory 134, when a position fix is requested (202). The usage information may include, for example, the time of the position fix, the day of the week, velocity and/or the location/position of the mobile station. For example, the start and end points of each navigation trip may be stored in the memory 134. A processing unit (e.g., processing unit 132) can be adapted to perform the illustrative method of FIG. 3, for example, by executing software code (e.g., software 138) and/or firmware code (e.g., firmware 140).

A usage pattern is then determined based on the usage information (204) and stored in memory 134. The usage pattern may be determined using usage information from one or more previous position fixes. For example, to minimize memory requirements, usage information from only the last position fix may be used to modify a previously determined usage pattern. The usage pattern may be determined by analyzing the stored usage information using one or more of signal processing algorithms used in fields of machine learning, such as statistical time series analysis and frequency domain analysis and may be based on pattern recognition, artificial neural networks, hidden Markov models, histograms, and Power Spectral Density. If desired, additional information may be used to determine the usage pattern. For example, in one embodiment, the stored usage information may be used to customize a generalized usage pattern. One generalized pattern may be based on user behavior such as the frequency of position fix requests with respect to: 1. time (e.g., users are less likely to use navigation between 1 am and 4 am); 2. day of the week (e.g., users are more likely to use navigation on weekends as opposed to weekdays); and 3. position (e.g., users are more likely to use navigation, if they are more than 50 miles away from their “home” address).

The resulting usage pattern may be in the form of a likelihood function, e.g., the probability that the next request for a position fix will be made at any time. By way of example, FIG. 4 is a table illustrating a usage pattern in the form of a likelihood function for a single day. It should be understood that the usage pattern may include multiple days, e.g., a week or more, and may have greater or less temporal granularity, e.g., the usage pattern may be a continuous function or may be based on any desired number of minute increments, such as 1, 5, 10, or 30 minute increments. As illustrated in FIG. 4, based on usage information from previous position fixes, there is a 0% probability of a position fix request occurring between 12 am and 5 am, and the probability increases from 40% to 70% between 5 am to 7 am and 7 am to 8 am respectively. It should be understood that the usage pattern may be different for different days of the week, e.g., it may be more likely that a request for a position fix occurs on the weekend than on a weekday.

Moreover, the determined usage pattern may include a geographic component as well as the temporal component. For example, the usage pattern may be different when the mobile station is at a familiar location than when the mobile station is in a distant location. In one embodiment, one or more additional usage patterns may be generated for specific locations or regions. Alternatively or additionally, one or more additional usage patterns may be generated based on distance from a “home” address, e.g., a user identified address or the most frequent location of the mobile station. For example, one set of usage patterns may be generated for when the mobile station is within 50 miles of the “home” address, while another set of usage patterns may be generated for when the mobile station is more than 50 miles from the “home” address.

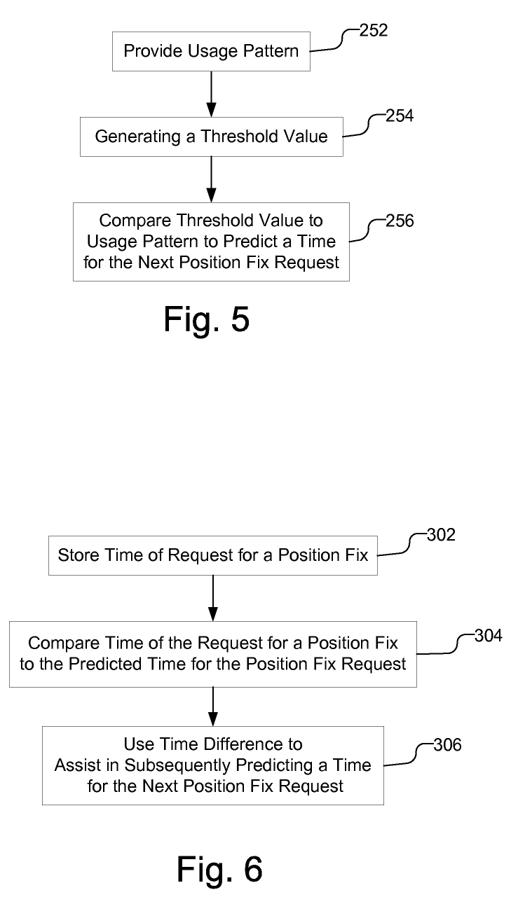

Using the determined usage pattern, a prediction of the time for the next position fix request is made (206). The prediction may be performed, e.g., when the mobile station is powered-down or placed in a sleep mode. The prediction of the time for the next position fix request may be made by comparing the usage pattern to a threshold value. FIG. 5 is a flow chart of the use of a threshold value in the prediction of the time for the next position fix request. As illustrated in FIG. 5, the usage pattern is provided (252). For example, if multiple usage patterns are generated, as discussed above, the appropriate usage pattern is selected. A threshold value is generated (254) and compared to the usage pattern to predict the time of the next position fix request (256). The threshold value is used to determine when the computed likelihood is sufficiently high that a background position fix is desirable. For example, referring to FIG. 4, if the prediction is performed at 12 am and the threshold value is set at 70, the predicted time for the next position fix request will be at 7 am. With a lower threshold value, e.g., 40, the predicted time for the next position fix will be 5 am.

The threshold value may be a static value, e.g., 70 in the above example, or may be a dynamic value that is varied based on internal and/or external factors. For example, the threshold value may be varied to compensate for excessive inaccuracy in the prediction which may be determined using e.g., Neiman-Pierson criteria. Additionally, the threshold value may vary based on the remaining battery power of the mobile station, e.g., as determined by the battery and power control unit 144 (FIG. 2) at the time that the prediction is performed. Where it is determined that the battery power is low, the threshold value may be dynamically varied so as to require an increased likelihood for the next position fix request. For example, with respect to FIG. 4, if the battery power is low, the threshold value may be increased to 75, so that the predicted time for the next position fix request is 4 pm. In other words, the likelihood of a position fix request occurring at 7 am is considered too low in this example to warrant using the remaining battery power to perform a background position fix at that time. Another factor that may be used to vary the threshold value is the last known position of the mobile station. Memory 134, for example, is adapted to store the last known position of the mobile station. As the distance between the last known location and the home location increases, the threshold value may be dynamically varied so as to require a decreased likelihood for the next position fix request. Other factors that may be used to vary the threshold value include time, day of the week, and the time since the last position fix request. For example, if a position fix request has not been performed in an extended period of time, the threshold value may be varied so as to require an increased likelihood for the next position fix request and, ultimately, may prevent any background position fixes from occurring.

The prediction of the time for the next position fix request may be performed, e.g., at the time when the mobile station is powered-down or placed in sleep mode. Alternatively, the prediction may be made on a periodic basis and stored in memory, with the last prediction serving as the effective prediction at the time of powering-down or going into sleep mode. The predicted time is stored, e.g., in memory 134. In one embodiment, instead of storing the predicted time in memory, the predicted time minus the time necessary to perform the background position fix is stored in memory. For example, if the predicted time is 7 am and a “cold start” position fix requires 15 minutes, 6:45 am is stored in memory. The mobile station is placed in a sleep mode, in which the clock 142 continues operating. As indicated in FIG. 3, when the clock 142 reaches the appropriate time, e.g., 6:45 am, the mobile station wakes from the sleep mode (208). In one embodiment, a prediction of the time for the next background fix request may be performed again (210). For example, the new prediction may be performed using an updated threshold value that is appropriate for the current battery power level or any other relevant conditions that may have changed. If the new prediction results in a different time (212), background position fix does not proceed and the mobile station goes back to sleep and is re-awoken at the appropriate time (208). If the new prediction results in the same time (212), background position fix is performed and/or ephemeris is downloaded (214). In some embodiments, the new prediction (210) may be eliminated and the process may proceed directly to performing the background position fix and/or downloading ephemeris (214).

The background position fix is performed before the predicted time for the next position fix request so that there is sufficient time for the background position fix to be completed prior to the predicted time for the next position fix request. It should be understood that the background position fix may include not only the location for the mobile station, but may also include a time fix and the frequency bias, e.g., when the position fix is performed using an SPS. The time fix and frequency bias may be used to correct the SPS signals when the actual position fix is requested. The time fix and frequency bias remain useful even if there is a substantial delay between the background position fix and the actual position fix request. For example, a low power sleep clock, e.g., clock 142, deviates at a rate that is not significant over a couple of hours, but that will produce errors if not corrected after an extended period, e.g., a day or more. Consequently, determining a time fix with the background position fix is useful even if the request for a position fix is not made for several hours. Similarly, the oscillators in the mobile station will drift over time, typically several hours or more, due to changes in, e.g., voltage levels and humidity. Therefore, determining the frequency bias of the oscillator in the mobile station may be useful even if the request for a position fix is not made for several hours.

The background position fix may alternatively be performed using data from cellular towers or from wireless access points. The result of the position fix is stored in the mobile station 100, e.g., in memory 134. Additionally or alternatively, the ephemeris may be downloaded before the predicted time for the next position fix request (214). The mobile station may be placed in sleep mode again until the next position fix request is made by the user. If desired, before going back into sleep mode, the mobile station may perform another prediction of a time for the next position fix request (206), e.g., when the current background position fix will be considered old.

By performing a background position fix close in time to the next position fix request, the Time to First Fix (TTFF) is significantly improved. The background position fix can provide the precise location and time of the mobile station. If the background position fix is close enough in time to the next position fix request, the mobile station will be in a “hot start” mode at the time of the next position fix request. Even if the background position fix is not performed immediately before the next position fix, e.g., the time between the background position fix and the next position fix is 30 minutes or greater, the TTFF may still be significantly improved, particularly when the satellite signals are at low levels.

If desired, the accuracy of the prediction of the time for the next position fix may be used to assist in future predictions of position fix requests. As illustrated in FIG. 6, the time when the next position fix request is actually made may be stored (302) and compared to the predicted time for the next position fix request (304). The time difference between the predicted time and the actual time of the next position fix request is then used to assist in subsequently predicting a time for a next position fix request (306). For example, the threshold value used in predicting the time (206 in FIG. 3) may be varied in response to the time difference, e.g., where there is a large time difference the threshold may be dynamically varied so as to require an increased likelihood of a next position fix request. Additionally, the usage information related to the position request, e.g., time, location, etc., may be stored and used in the determination of usage pattern as discussed above (202 and 204).

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
storing usage information when a position fix for a mobile station is requested;
determining a usage pattern for position fix requests for the mobile station using the stored usage information;
predicting a time for a next position fix request for the mobile station based on the usage pattern; and
performing a position fix for the mobile station before the predicted time for the next position fix request.

2. The method of claim 1, further comprising:
storing a time of the next position fix request;
comparing the time of the next position fix request with the predicted time for the next position fix request to determine a time difference;
using the time difference to assist in subsequently predicting a time for a next position fix request.

3. The method of claim 1, wherein usage information comprises at least one of a time, a day of the week, and a position when a position fix is requested.

4. The method of claim 1, wherein the usage pattern comprises frequency of position fix requests with respect to at least one of time, day of the week, and position.

5. The method of claim 1, further comprising providing a threshold value, wherein predicting a time for a next position fix request comprises comparing the usage pattern to the threshold value.

6. The method of claim 5, wherein the threshold value is altered based on battery power of the mobile station.

7. The method of claim 5, further comprising storing a last known position of the mobile station, wherein the threshold value is altered based on the last known position of the mobile station.

8. The method of claim 1, further comprising downloading ephemeris for the mobile station before the predicted time for the next position fix request.

9. The method of claim 1, wherein performing a position fix for the mobile station comprises determining a time fix and a frequency bias.

10. A mobile station comprising:
a position location system adapted to determine a position fix for the mobile station;
a processing unit coupled to the position location system, the processing unit adapted to:
determine a usage pattern for position fix requests for the mobile station using usage information stored in the memory;
predict a time for a next position fix request for the mobile station based on the usage pattern; and
control the position location system to determine a position fix for the mobile station before the predicted time for the next position fix request;
and a memory coupled to the processing unit.

11. The mobile station of claim 10, wherein the usage information comprises at least one of a time, a day of the week, and a position when a position fix is requested and the usage pattern comprises frequency of position fix requests with respect to at least one of time, day of the week, and position.

12. The mobile station of claim 10, wherein the processing unit is further adapted to compare the usage pattern to a threshold value to predict a time for a next position fix request for the mobile station based on the usage pattern.

13. The mobile station of claim 12, further comprising a battery and power control unit adapted to provide batter power data to the processing unit, wherein the processing unit is further adapted to alter the threshold value based on the battery power data.

14. The mobile station of claim 12, wherein the memory is adapted to store the last known position of the mobile station, and wherein the processing unit is further adapted to alter the threshold value based on the last known position.

15. The mobile station of claim 10, wherein the processing unit is further adapted to download ephemeris for the mobile station before the predicted time for the next position fix request.

16. The mobile station of claim 10, wherein the position fix comprises a time fix and a frequency bias.

17. A mobile station comprising:
means for storing usage information when a position fix for the mobile station is requested;
means for determining a usage pattern for position fix requests for the mobile station using the stored usage information;
means for predicting a time for a next position fix request for the mobile station based on the usage pattern; and
means for performing a position fix for the mobile station before the predicted time for the next position fix request.

18. The mobile station of claim 17, further comprising:
means for storing a time of the next position fix request;
means for comparing the time of the next position fix request with the predicted time for the next position fix request to determine a time difference; and
means for using the time difference to assist in subsequently predicting a time for a next position fix request.

19. The mobile station of claim 17, wherein usage information comprises at least one of a time, a day of the week, and a position when a position fix is requested and the usage pattern comprises frequency of position fix requests with respect to at least one of time, day of the week, and position.

20. The mobile station of claim 17, further comprising means for providing a threshold value, wherein the means for predicting a time for a next position fix request comprises a means for comparing the usage pattern to the threshold value.

21. The mobile station of claim 20, further comprising means for monitoring battery power of the mobile station, wherein the threshold value is altered based on the battery power of the mobile station.

22. The mobile station of claim 20, further comprising means for storing a last known position of the mobile station, wherein the threshold value is altered based on the last known position of the mobile station.

23. The mobile station of claim 17, further comprising means for downloading ephemeris data before the predicted time for the next position fix request.

24. The mobile station of claim 17, wherein the position fix comprises a time fix and a frequency bias.

25. A computer-readable medium encoded with instructions, when executed by a processing unit, the instructions perform positioning, the instructions comprising:
code to determine a usage pattern for position fix requests for a mobile station using stored usage information from when a position fix for a mobile station is requested;
code to predict a time for a next position fix request for the mobile station based on the usage pattern; and
code to determine a position fix for the mobile station before the predicted time for the next position fix request.

26. The computer-readable medium of claim 25, the instructions further comprising:
code to store a time of the next position fix request;
code to compare the time of the next position fix request with the predicted time for the next position fix request to determine a time difference; and
code to use the time difference to assist in subsequently predicting a time for a next position fix request.

27. The computer-readable medium of claim 25, wherein the usage information comprises at least one of a time, a day of the week, and a position when a position fix is requested and the usage pattern comprises frequency of position fix requests with respect to at least one of time, day of the week, and position.

28. The computer-readable medium of claim 25, wherein the code to predict a time for a next position fix request for the mobile station based on the usage pattern comprises code to compare the usage pattern to a threshold value.

29. The computer-readable medium of claim 28, the instructions further comprising code to alter the threshold value based on battery power of the mobile station.

30. The computer-readable medium of claim 28, the instructions further comprising code to alter the threshold value based on a last known position of the mobile station.

31. The computer-readable medium of claim 25, the instructions further comprising code to download ephemeris before the predicted time for the next position fix request.

32. The computer-readable medium of claim 25, wherein the position fix comprises a time fix and a frequency bias.
